(19) United States
(12) Patent Application Publication
(10) Pub. No.: US 2022/0232858 A1
(43) Pub. Date: Jul. 28, 2022

(54) HARDLY SOLUBLE BEVERAGE PRODUCT

(71) Applicant: DAIWA CAN COMPANY, Chiyoda-ku (JP)

(72) Inventors: Eiji FUJISHIGE, Sagamihara-shi (JP); Tatsuhei YAMAMOTO, Chiyoda-ku (JP); Kenji SUGIMOTO, Chiyoda-ku (JP); Shuji KAJITA, Chiyoda-ku (JP); Seiji NAGAZUMI, Chiyoda-ku (JP); Susumu MATSUOKA, Miyaki-gun (JP)

(73) Assignee: DAIWA CAN COMPANY, Chiyoda-ku (JP)

(21) Appl. No.: 17/621,118

(22) PCT Filed: Jun. 12, 2020
(86) PCT No.: PCT/JP2020/023162

§ 371 Date: Dec. 20, 2021

(30) Foreign Application Priority Data
Jun. 21, 2019 (JP) 2019-115439

(51) Int. Cl. A23L 2/39; A23C 9/152; A23L 2/66; B65D 85/816; B65D 85/72; B65D 81/32; B65D 81/20

(52) U.S. Cl. CPC A23L 2/39; A23C 9/152; A23L 2/66; B65D 85/816; A23C 2270/10; B65D 81/32; B65D 81/20; A23C 2210/30; A23C 2260/20; B65D 85/72

(57) ABSTRACT

A hardly soluble beverage product, comprising: a container comprising a main body that contains a content and that has a container mouth as an outlet of the content, and a cap that is mounted on the container mouth to close the main body. An internal volume of the container is set to a total of: a volume corresponding to a volume of the powder material contained in the container; a volume corresponding to an amount of the liquid determined in accordance with an amount of the powder material to be mixed or dissolved with the liquid; and a volume as an extra space to cause turbulence of the powder material and the liquid.

### TECHNICAL FIELD

The present invention relates to a hardly insoluble beverage product that is prepared by dissolving powdered ingredient such as powdered milk or protein in aqueous solution such as water to be drinkable.

### BACKGROUND ART

In the prior art, there are known powdered beverage products having improved portability and preservability, and such powdered beverage products are to be dissolved, dispersed, or mixed in liquid such as water or milk. Such powdered beverage products may be exemplified by powdered milk and powdered protein.

The powdered beverage (product) has not yet been dissolved or mixed in the liquid, and maintained in the form of powder. Therefore, loss and dissolution of nutrient content in the powdered beverage are less than those of beverage products commoditized by mixing powder material in liquid while heating. In addition, it is not necessary to dissolve the powdered beverage for the purpose of preventing precipitation during storage or display in stores. For this reason, it is possible to provide high concentration beverage products to consumers.

One example of beverage product of this kind is described in Japanese Patent Laid-Open No. 2016-30198. Specifically, Japanese Patent Laid-Open No. 2016-30198 describes a preparation kit of milk for baby in which a feeding bottle, a nipple, a sterilization-treated water and an exothermic agent are accommodated in a case. According to the teachings of Japanese Patent Laid-Open No. 2016-30198, therefore, milk can be prepared anytime and anywhere.

Japanese Patent Laid-Open No. 2000-237068 describes a stir vessel set in which liquid material and another liquid material to be mixed with the liquid material are held in a vessel. Specifically, liquid material is held in a main vessel in which an upper opening is sealed liquid-tightly, and a lid body having a sufficient capacity is mounted on the upper opening of the main vessel. A mixed material storing vessel is held in the lid body, and another liquid material is held in the mixed material storing vessel. A spout is formed on a ceiling of the lid body, and the spout is closed by a detachable cap. According to the teachings of Japanese Patent Laid-Open No. 2000-237068, another liquid material (e.g., lime) is put into the liquid material (e.g., alcoholic beverage) by dismounting the lid body and unsealing the upper opening of the main vessel. Thereafter, the main vessel is closed by the lid body again, and shaken to mix another liquid material with the liquid material. The resultant beverage is poured into a glass from the spout to be drunk.

### SUMMARY OF INVENTION

### Technical Problem to be Solved by the Invention

As explained in Japanese Patent Laid-Open No. 2016-30198, concentration of the powdered beverage to be mixed with liquid is high when drunk. However, the powdered beverage product to be mixed with liquid such as powdered milk and powdered protein is not easy to be dissolved e.g., in water. For example, some of the powders would float on the water, some of the powders would form clumps in the water, and some of the powders would become deposited in the water.

According to the teachings of Japanese Patent Laid-Open No. 2016-30198, in order to dissolve the powdered milk easily in water, the powdered milk and the water in the feeding bottle is heated by the exothermic agent. However, in the kit of this kind, it can be argued that not only the powdered milk but also a modification of a kitchen equipment are held in the case. Therefore, a size of the kid has to be increased thereby reducing a portability of the kit. In addition, since the kit described in Japanese Patent Laid-Open No. 2016-30198 includes sufficient parts or components, a manufacturing cost of the kit may be increased and hence an application of the kit may be limited. Further, the kit has to be washed to reuse the kit. That is, user friendliness and easiness of the kit may be insufficient. For example, protein beverage is often drunk after exercise as a leisure. That is, a flavor and a concentration of the protein beverage are important for consumers, and the easiness of preparation of the protein beverage is also important to be handled by the consumers who may be tired. In order to fulfil those requirements, the protein beverage is manufactured in the form of powder, and mixed with water or milk when drunk. However, since user friendliness and portability of the kit described in Japanese Patent Laid-Open No. 2016-30198 are unsatisfactory, the kit may be not suitable for the powdered beverage which is to be drunk after exercise or workout, and hence it may be difficult to put the kit described in Japanese Patent Laid-Open No. 2016-30198 into practical application to contain the powered material to be consumed after exercise or workout.

On the other hand, in the stir vessel set described in Japanese Patent Laid-Open No. 2000-237068, the main vessel may be used as a shaker so that another liquid material may be mixed or dispersed easily in the liquid material. However, another liquid material to be mixed with the liquid material is held liquid-tightly in another vessel that is held in the main vessel. Thus, a structure of the stir vessel set is rather complicated and a size of the stir vessel set is rather large. For this reason, a cost of the stir vessel set may be too expensive. In addition, since the liquid material is held in the main vessel, a concentration and an amount of beverage may not be changed after mixing another liquid material with the liquid material. Therefore, given that the powdered milk or protein is held in another vessel instead of another liquid material, the stir vessel set described in Japanese Patent Laid-Open No. 2000-237068 may not fulfil the requirements of portability and user friendliness, and in addition, a cost of the stir vessel set would be expensive.

In the conventional art, freeze-dried powdered beverage products such as powdered coffee are also packed in a stick formed of sheet material. This kind of powdered beverage is merely packed in a stick to be carried easily, and hence a container and a mixing utensil are required to mix the powdered beverage with water. Therefore, it is difficult to put this kind of powdered beverage into practical use at a site where a beverage container and a mixing utensil are not available.

The present invention has been conceived noting the foregoing technical problems, and it is therefore an object of the present invention to provide a hardly soluble beverage product that is easily to be carried and mixed with liquid, and a concentration thereof can be adjusted easily.

### Means for Solving the Problem

According to one aspect of the present invention, there is provided a hardly soluble beverage product comprising a container comprising a main body that contains a content and that has a container mouth as an outlet of the content, and a cap that is mounted on the container mouth to close the main body. The main body can be closed again by mounting the cap on the container mouth, after dismounting the cap from the container mouth. The content includes hardly soluble powder material that is dissolved in a predetermined liquid or mixed with the predetermined liquid to be drunk. In order to achieve the above-explained objective, according to the present invention, an internal volume of the container is set to a total of: a volume corresponding to a volume of the powder material contained in the container; a volume corresponding to an amount of the liquid determined in accordance with an amount of the powder material to be mixed or dissolved with the liquid; and a volume as an extra space to cause turbulence of the powder material and the liquid.

According to the present invention, a ratio of the volume as the extra space to the amount of the liquid may be set within a range from 20% to 85%.

According to the present invention, liquid nitrogen may be delivered to the main body, and an internal pressure of the container may be set to a level higher than an atmospheric air pressure at a site where the cap is dismounted to put the liquid into the main body.

According to the present invention, an upper limit of internal pressure of the main body may be set to a level at which the powder material will not be ejected together with a gas when dismounting the cap.

According to the present invention, the upper limit of the internal pressure of the main body may be set to 50 kPa.

According to the present invention, a lower limit of the internal pressure of the main body may be set to 7 kPa.

According to the present invention, the container may include a metallic can having a predetermined rigidity to maintain a shape thereof when dismounting the cap.

According to the present invention, an outer diameter of the container mouth may be equal to or larger than 38 mm.

According to the present invention, a light transmissivity of the main body at an amount observing level to observe the amount of the liquid delivered to the container may be equal to or greater than 30%.

According to the present invention, a scale may be printed on the main body at the amount observing level to observe the amount of the liquid delivered to the container.

According to the present invention, the main body may comprise: a cylindrical trunk section; a cylindrical neck section on which the container mouth is formed, and which is diametrically smaller than the trunk section; and a shoulder section having a conical or domed shape formed between the trunk section and the neck section.

According to the present invention, the powder material may include insoluble solid matter.

According to the present invention, the powder material may include powdered protein and granulated protein.

According to the present invention, an average particle size of the powder material may fall within a range from 40 to 1200 μm.

According to the present invention, the liquid may include tap water, hydrogen water, mineral water, ion water, milk, processed milk, and milk beverage.

### Advantageous Effects of Invention

According to the present invention, the powder material that is to be dissolved in the liquid or mixed with the liquid is contained in the container. That is, the liquid is not contained in the container before drunk. Therefore, the beverage does not have to be subjected to an excessive heat sterilization during the manufacturing process to avoid degradation of the beverage. In addition, a concentration of the beverage may be adjusted by adjusting an amount of the liquid to be added. Therefore, a concentration of nutrition in the beverage may be maintained sufficiently high. In other words, nutrient content with respect to an amount of the liquid may be increased. In addition, since the liquid is to be put into the container when drinking the beverage, portability of the beverage product is improved compared to the conventional beverage products in which powder material has already been mixed with liquid during manufacturing process.

In addition, the internal volume of the container is set to a total of: the volume corresponding to a volume of the powder material contained in the container; the volume corresponding to an amount of the liquid determined in accordance with an amount of the powder material to be mixed or dissolved with the liquid; and the volume as an extra space to cause turbulence of the powder material and the liquid. Therefore, after putting the liquid into the container and mounting the cap on the container mouth again, the container 3 may be used as a shaker. That is, it is not necessary to prepare a dedicated shaker for mixing the powder material with the liquid, and hence the portability of the beverage product is further improved.

### BRIEF DESCRIPTION OF DRAWINGS

FIG. 1 is a front view showing one example of a hardly soluble beverage product according to the embodiment of the present invention.

FIG. 2 is a side view showing one example of a cap according to the embodiment of the present invention.

FIG. 3 is a schematic illustration showing a manufacturing method of the hardly soluble beverage product according to the embodiment of the present invention.

FIG. 4 is an explanatory drawing showing procedures of putting liquid into a container according to the embodiment of the present invention, and mixing or dissolving powder material with liquid.

### DESCRIPTION OF EMBODIMENT(S)

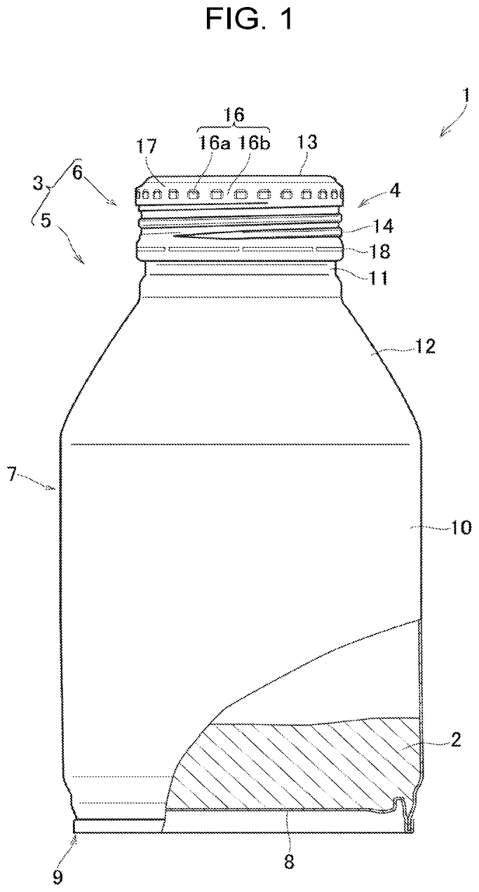

One example of the hardly soluble beverage product according to the embodiment of the present invention is shown in FIG. 1. In the hardly soluble beverage product 1 shown in FIG. 1, powder material 2 that is dissolved in or mixed with predetermined liquid to be drunk is contained in a sealed container (hereinafter simply called the “container”) 3. The powder material 2 contains protein and vitamin, and for example, the powder material 2 includes powders or granules of milk, whey protein, casein protein, soy protein and so on. Particle size (or grain diameter) of the powder material 2 is adapted to dissolve the powder material 2 in the liquid. Specifically, an (average) particle size of the powder material 2 falls within a range from 40 to 1200 μm. According to the present invention, in order to obtain the average particle size of the powder material 2, a predetermined amount of sample was extracted from the powder material 2, and the most common size or diameter of grain measured by an electronic microscope was employed as the average particle size. The container 3 as a resealable container includes a metallic can made of aluminum alloy sheet or a surface-treated steel sheet, and a PET bottle. As illustrated in FIG. 1, the container 3 comprises a main body 5 containing the powder material 2; a container mouth 4 as an outlet formed on the main body 5; and a cap 6 mounted on the container mouth 4 to close the main body 5.

The main body 5 comprises: a cylindrical trunk section 7; and a bottom lid 8 closing an opening end (i.e., a lower end) of the trunk section 7. In the example shown in FIG. 1, an outer diameter of the trunk section 7 is approximately 66 mm, and an outer diameter of a lower end 9 thereof is smaller than the outer diameter of the trunk section 7. Whereas, an outer diameter of an opening end of the container mouth 4 is approximately 38 mm. The main body 5 further comprises: a diametrically larger cylindrical section (to be referred to as the “diametrically larger section” 10 formed from the lower end 9; a cylindrical section (to be referred to as the “neck section”) 11 formed from the container mount 4; and a shoulder section 12 formed between the diametrically larger section 10 and the neck section 11. A thread ridge is formed on an outer circumferential surface of the neck section 11, and a diameter of the shoulder section 12 is reduced gradually toward the neck section 11. A capacity of the diametrically larger section 10 is approximately 300 ml. The bottom lid 8 as a disc member is seamed to the lower end 9 thereby closing the lower end 9. Here, in the container 3 according to the embodiment of the present invention, the trunk section 7 and the bottom lid 8 may also be formed integrally, and a structure of the container 3 should not be limited.

The cap 6 closing the container mouth 4 comprises: a top panel 13 as a disc section whose outer diameter is identical to or slightly larger than an outer diameter of the container mouth 4; and a skirt 14 as a cylindrical section sagging from an outer circumference of the top panel 13 toward the trunk section 7.

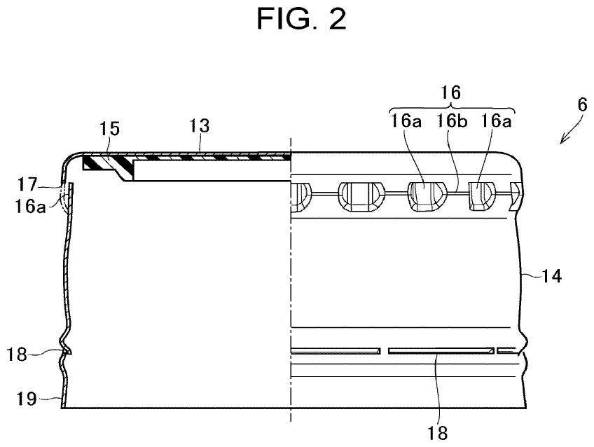

One example of the cap 6 is shown in FIG. 2. As illustrated in FIG. 2, a liner 15 made of synthetic resin is affixed to an inner surface of the top panel 13. The liner 15 may be shaped into a disc shape or an annular shape. A knurled section 16 is formed on an upper section of the skirt 14, and in the knurled section 16, dents 16a and bumps 16b are formed alternately in a circumferential direction all around the skirt 14. In order to release gas contained in the main body 5 smoothly when dismounting the cap 6, a plurality of vent slits 17 are formed intermittently in the circumferential direction above each of the dents 16a and bumps 16b.

The cap 6 having the above-explained structure is mounted on the container mouth 4 by a roll-on capping method. Specifically, a rough material of the cap 6 is mounted on the container mouth 4 such that the liner 15 is brought into close contact to an edge of the container mouth 4, and that the neck section 11 is covered by the skirt 14. Then, the skirt 14 is pressed radially inwardly onto the neck section 11 by rollers (not shown) along the thread ridge so that the skirt 14 is threaded. A lower end of the skirt 14 is depressed toward the neck section 11 entirely in the circumferential direction, and a plurality of slits 18 are formed intermittently in the depression of the skirt 14. Therefore, after the cap 6 is twisted, a portion of the skirt 14 below the slits 18 (i.e., a pilfer-proof ring 19) will remain around the neck section 11. Here, FIG. 1 shows the skirt 14 on which the thread is formed, and FIG. 2 shows the skirt 14 before the thread is formed thereon (i.e., the rough material of the cap).

The powder material 2 is contained the container 3. According to the embodiment of the present invention, 30 g of the powder material 2 is contained the container 3.

According to the embodiment of the present invention, the powder material 2 which has not yet been dissolved in or mixed with the liquid is contained in the container 3. After dismounting the cap 6 from the container 3, the container 3 will be filled with a required amount of liquid by a consumer to be mixed with the powder material 2. Thereafter, the container mouth 4 will be closed by the cap 6 again, and the container 3 as a shaker will be shaken by the consumer to dissolve or mix the powder material 2 with the liquid. To this end, the container 3 has an internal volume as a total of: a volume V1 corresponding to a volume of the powder material 2 to be contained in the main body 5; a volume V2 corresponding to an amount of the liquid determined in accordance with an amount of the powder material 2 to be mixed or dissolved with the liquid; and a volume V3 as an extra space to cause turbulence of the powder material 2 and the liquid so as to expedite dissolution of the powder material 2 in the liquid.

Inventors of the present invention have confirmed that the powder material 2 (e.g., protein) can be dissolved well in the liquid (e.g., water) to be drinkable by shaking the container 3 after closing the container mouth 4 by the cap 6 in the following conditions. In a metallic can having the shoulder section 12 in which an outer diameter of the trunk section 7 is approximately 66 mm, an outer diameter of the container mouth 4 is approximately 38 mm, and a total internal volume is approximately 280 ml, 15 grams of the powder material 2 can be dissolved in or mixed well with 150 ml to 190 ml of the liquid in the container 3. In a metallic can having the shoulder section 12 in which an outer diameter of the trunk section 7 is approximately 66 mm, an outer diameter of the container mouth 4 is approximately 38 mm, and an internal volume of the diametrically larger section 10 is approximately 350 ml, 20 grams of the powder material 2 can be dissolved in or mixed well with 200 ml to 250 ml of the liquid in the container 3. In a metallic can having the shoulder section 12 in which an outer diameter of the trunk section 7 is approximately 66 mm, an outer diameter of the container mouth 4 is approximately 38 mm, and an internal volume of the diametrically larger section 10 is approximately 450 ml, 30 grams of the powder material 2 can be dissolved in or mixed well with 300 ml to 375 ml of the liquid in the container 3. Based on the above experimental results, the inventors have found that it is preferable to set a ratio of the volume V3 as the extra space to the total volume of the liquid mixed with the powder material 2 within a range from 20% to 85%. In the example shown in FIG. 1, given that the container 3 is an aluminum can whose internal volume is 350 ml and that 30 grams of the powder material 2 is contained in the container 3, the volume V3 can be maintained by filling the diametrically larger section 10 with the liquid such as water or milk.

According to the embodiment of the present invention, an internal volume of the container 3 should not be limited to 350 ml. For example, given that 40 grams of the powder material 2 is to be contained in the container 3, an outer diameter of the lower end 9 may be set to approximately 66 mm, an outer diameter of the container mouth 4 may be set to approximately 38 mm, an internal volume of the diametrically larger section 10 may be set to approximately 400 ml, and a total internal volume of the container 3 may be set to approximately 450 ml. Thus, dimensions of the container 3 may be adjusted according to an amount of the powder material 2 to be contained therein.

According to the embodiment of the present invention, means for sealing the container 3 should not be limited to the thread as long as the container 3 can be resealed after decapping the main body 5.

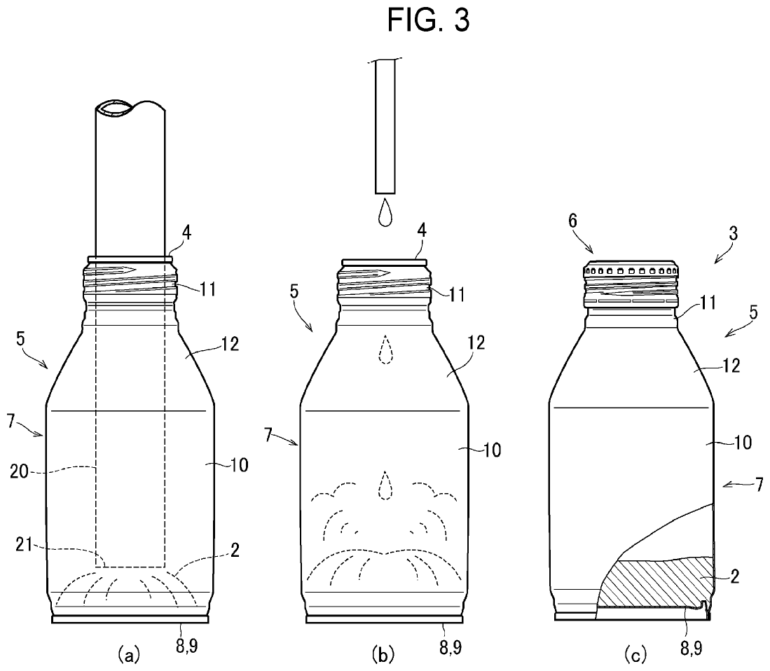

Next, here will be explained a manufacturing method of the hardly soluble beverage product 1 with reference to FIG. 3. More specifically, here will be explained methods of feeding the powder material 2 into the container 3, and capping the container 3 containing the powder material 2. FIG. 3(a) shows a feeding step of the powder material 2 to the container 3, and at the feeding step, a nozzle 20 is inserted into the container mouth 4 to feed the powder material 2 to the main body 5. In the example shown in FIG. 3(a), in order to prevent ejection of the powder material 2 from the main body 5, the nozzle 20 is inserted into the main body 5 such that an opening end 21 of the nozzle 20 is situated in the vicinity of a lower end of the trunk section 7. For example, the feeding step is executed while setting the container 3 on a weighing equipment, and feeding of the powder material 2 is terminated when a total weight of the container 3 and the powder material 2 reaches a target weight. Instead, the powder material 2 may also be measured in advance to be prepared in a target amount. In this case, the target amount of the powder material 2 may also be fed to the main body 5 through the nozzle 20.

After thus feeding the powder material 2 into the main body 5, in order to prevent partial deformation and oxidization of the container 3 due to temperature change or the like after mounting the cap 6, liquid nitrogen is delivered to the container 3. For example, as shown in FIG. 3(b), the liquid nitrogen is delivered to the main body 5 in the form of drop. An amount of the liquid nitrogen to be delivered to the container 3 is determined such that an internal pressure of the container 3 is raised for precaution. To this end, an amount of reduction in the internal pressure at the destination of the beverage product 1 is estimated based on an expected change in environment such as a temperature at the destination, and an amount of the liquid nitrogen to be delivered to the container 3 is set to a value possible to raise the internal pressure of the container 3 in the estimated amount of the reduction. For example, provided that a temperature is 20 degrees C. when feeding the powder material 2 to the main body 5 and then an outside air temperature is expected to fall to zero degrees C., the internal pressure of the container 3 would be reduced in 7 kPa. Therefore, if the beverage product 1 will be transported to a site where a temperature is expected to drop to zero degrees C., a lower limit value of reduction of the internal pressure in the container 3 is set to 7 kPa, and an amount of the liquid nitrogen to be delivered to the container 3 is set to a value possible to raise the internal pressure of the container 3 in 7 kPa. Thus, an internal pressure of the container 3 is adjusted based on an amount of the liquid nitrogen to be delivered to the container 3.

If an internal pressure of the container 3 is excessively high, the powder material 2 would be ejected from the vent slits 17 together with nitrogen gas when dismounting the cap 6 to put water into the container 3. Therefore, it is preferable to set an upper limit of internal pressure of the container 3 to a level higher than an atmospheric air pressure at a site where the cap 6 is dismounted to put the liquid into the container 3, but lower than a level at which the powder material 2 will be ejected. Based on the experimental outcome, the inventors of the present invention have found that it is preferable to set the upper limit level of the internal pressure lower than 50 kPa.

After delivering the liquid nitrogen to the container 3, the cap 6 is mounted on the container mouth 4 by the roll-on capping method such that the liner 15 is brought into close contact to the edge of the container mouth 4. For example, as illustrated in FIG. 3(c), the skirt 14 is pressed by the forming rollers from radially outer side so that so that the skirt 14 is threaded along the thread ridge of the neck section 11. Consequently, the container 3 is closed. In this situation, as a result of vaporization of the liquid nitrogen, oxygen and moisture in the main body 5 is substituted into nitrogen gas in some measure.

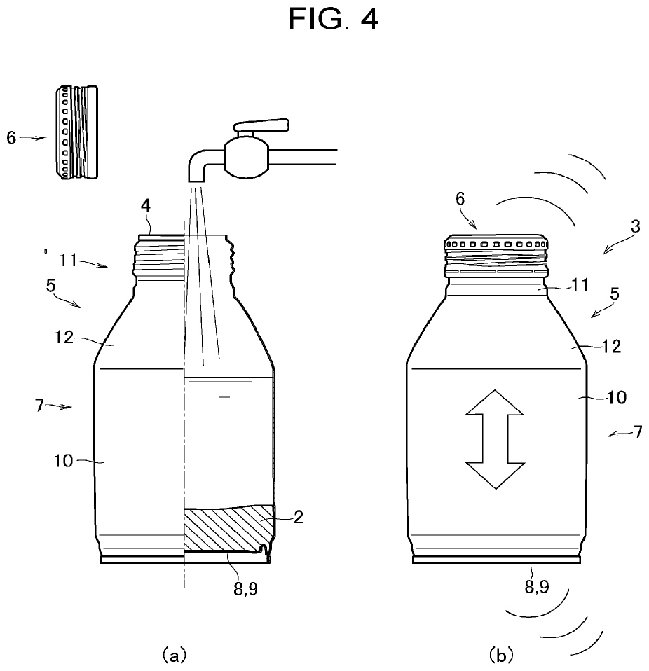

The beverage product 1 thus manufactured is prepared to be drunk by the following procedures. First of all, the cap 6 is dismounted from the container 3. Then, as illustrated in FIG. 4(a), the liquid is put into the container 3 such that the powder material 2 is dissolved in or mixed with the liquid in the container 3. As described, the internal pressure of the container 3 is set to a level slightly higher than the atmospheric air pressure, therefore, the gas contained in the container is ejected through the vent slits 17 when dismounting the cap 6. However, since the internal pressure is set lower than a level at which the powder material 2 will be ejected, ejection of the powder material 2 with the gas from the container 3 can be prevented almost completely. In addition, since the liquid to be mixed with the powder material 2 is not contained in the container 3 during storage, the powder material 2 will not be deteriorated during storage. Further, since the powder material 2 will not be headed during the manufacturing process, a concentration of protein and vitamin can be maintained sufficiently high.

The liquid to be put into the container 3 may be selected by the consumer. For example, the liquid may be selected from tap water, hydrogen water, mineral water, ion water, milk, processed milk, milk beverage and so on. In addition, the liquid may be warmed according to need. It is recommendable to adjust an amount of the liquid to be put into the container 3 in accordance with an amount of the powder material. That is, an internal volume of the container 3 is set in accordance with an amount of the powder material 2 and a required amount of the liquid to achieve an appropriate concentration of the beverage. Here, a recommended amount of the liquid has a predetermined margin of adjustment in the concentration of the beverage. However, an amount of the liquid may be adjusted beyond the margin of the recommended amount depending on the consumer's taste.

The powder material 2 as nutritious supplemental powder is not easy to be dissolved in the liquid or to be mixed with the liquid. In addition, given that the powder material 2 is soy protein powder, the powder material 2 may contain insoluble solid matter. Therefore, after putting the liquid into the container 3 by the above-explained procedures, the container 3 is resealed by the cap 6. Thereafter, as illustrated in FIG. 4(b), the container 3 on which the cap 6 is mounted is shaken. That is, the container 3 is used as a shaker. To this end, the internal volume of the container 3 includes the extra space to cause turbulence of the powder material 2 and the liquid so that the powder material 2 and the liquid may be agitated sufficiently by shaking the container 3. Consequently, the powder material 2 is dissolved or dispersed well in the liquid, or mixed well with the liquid.

In this situation, given that the extra space is insufficient (e.g., less than 20% of a volume of the liquid mixed with the powder material 2), some of the powder material 2 would form clumps in the liquid, and hence the powder material 2 and the liquid may not be agitated sufficiently. In this case, therefore, it would be necessary to shake the container 3 more frequently, and accordingly, it would take longer time to eliminate the clumps by shaking the container 3. By contrast, given that the extra space is excessively large (e.g., greater than 85% of a volume of the liquid mixed with the powder material 2), the liquid may not collide against an inner surface of the container 3 sufficiently frequently and hence it would be difficult to eliminate the clumps. That is, the liquid would merely reciprocate in the container 3 in most situations without causing a turbulence. For these reasons, it would also be necessary to shake the container 3 more frequently, and accordingly, it would also take longer time to eliminate the clumps by shaking the container 3. After shaking the container 3, the cap 6 is dismounted to drink the beverage thus prepared by mixing the powder material 2 with the liquid.

In general, the conventional beverage is prepared by mixing powder material with liquid in advance, and subjected to a heat sterilization so as to improve preservability thereof. For this reason, nutrient content of the powder material has to be degraded and hence a concentration of the beverage is reduced. Whereas, in the hardly soluble beverage product 1 according to the embodiment of the present invention, the powder material 2 is held in the container 3 in the form of powder, and mixed with the liquid before drinking the beverage. Therefore, the beverage product 1 does not have to be subjected to a heat sterilization during the manufacturing process. For this reason, the consumer is allowed to take high concentration nutrition from the beverage product 1. In other words, the concentration of the beverage to be drunk can be increased.

In addition, in the beverage product 1 according to the embodiment of the present invention, the powder material 2 is held in the container 3 as a shaker, and hence a weight of the beverage product 1 is light. For these reasons, the portability of the beverage product 1 is better than that of the conventional beverage product in which a container of the powder material and a shaker are separated. For example, given that the beverage product 1 contains the nutritious supplemental powder such as the powdered protein or milk, the beverage product 1 is often drunk after exercise or in the field. Therefore, the beverage product 1 according to the embodiment of the present invention is especially suitable to contain the nutritious supplemental powder to be carried.

Given that particle size of the powder material is relatively small, some of the powders would float on the liquid. Therefore, in general, the powdered milk or protein is agitated in a feeding bottle or shaker together with the liquid. In other words, a dedicated shaker is required to mix the powder material with the liquid. By contrast, according to the embodiment of the present invention, the container 3 containing the powder material 2 may be resealed by the cap 6. That is, after putting the liquid into the container 3 and mounting the cap 6 on the container mouth 4, the container 3 may be used as a shaker. For this reason, it is not necessary to prepare a dedicated shaker for mixing the powder material with the liquid and hence the portability of the beverage product is improved. In other words, according to the embodiment of the present invention, the container 3 serves not only as a container for containing the powder material 2 to be displayed and carried, but also as a shaker for mixing the powder material 2 with the liquid.

Moreover, according to the embodiment of the present invention, the container 3 has a structure similar to that of conventional beverage cans. Therefore, the container 3 may be thrown away and recycled as the conventional beverage cans. For these reasons, it is not necessary to wash the container 3 as required by the dedicated shaker, and it is not necessary to carry the empty container 3 (after drinking). Thus, the portability of the beverage product 1 is improved in those point of views.

As described, the container 3 may be made of metallic material. In this case, the container 3 has a sufficient rigidity to maintain its shape even after dismounting the cap 6, and hence the container 3 may be handled easily when putting the liquid into the container 3 and when shaking the container 3. In addition, external light may not be transmitted through the container 3 so that it is possible to prevent degradation of the nutrient content in the powder material 2. Further, moisture permeability of the container 3 made of metal is lower than that of the container 3 made of polyethylene terephthalate. In this case, therefore, it is possible to prevent the powder material 2 from becoming damp compared to the container 3 made of polyethylene terephthalate.

As also described, the container mouth 4 has a large opening, therefore, it is easy to put the liquid into the container 3. In addition, although it is impossible to visually grasp an amount of the liquid being delivered to the container 3 made of metal, the amount of the liquid in the container 3 may be visually grasped from above the opening of the container mouth 4. Therefore, it is easy to put the liquid into the container 3 in a desirable amount. As described, an outer diameter of the container mouth 4 may be set larger than 38 mm.

As also described, the inner surface of the trunk section 7 is smooth. Specifically, both of the diametrically larger section 10 and the neck section 11 have a cylindrical shape, and the diametrically larger section 10 and the neck section 11 are connected through the shoulder section 12 having a conical or domed shape. Therefore, a flow resistance of the beverage being drunk can be reduced, and undissolved or unmixed powder will not remain in the container 3. That is, the consumer is allowed to take nutrition as desired.

Further, since an internal pressure of the container 3 is raised, it is possible to hold the trunk section 7 tightly so that a sufficient reaction force is ensured against an opening torque applied to the cap 6 without deformation of the trunk section 7. Furthermore, a flow in the container 3 such as a hole can be inspected by a tactile inspection (to find a load by which the container 3 is deformed) before shipping the beverage product 1. Therefore, the manufacturing process of the beverage produce 1 can be simplified.

The hardly soluble beverage product according to the embodiment of the present invention should not be limited to the foregoing beverage product in which the powder material 2 is contained in the container 3. For example, in order to grasp an amount of the liquid delivered to the container 3, a portion of the trunk section 7 at a level of the liquid delivered to the container 3 in a predetermined amount (i.e., an amount observing level) may be formed of material whose transmissivity is equal to or greater than 30%. Instead, the container 3 may also be formed entirely of polyethylene terephthalate whose transmissivity is equal to or greater than 30%. In this case, in order to shield the powder material 2 from light, it is preferable to cover a portion of the container 3 in which the powder material 2 is held by a masking or the like. Optionally, a scale may be printed on the trunk section 7 at the level of the liquid to be delivered to the container 3 in a required amount.

1. A hardly soluble beverage product, comprising:
a container comprising a main body that contains a content and that has a container mouth as an outlet of the content, and a cap that is mounted on the container mouth to close the main body,
wherein the main body can be closed again by mounting the cap on the container mouth, after dismounting the cap from the container mouth,
the content includes hardly soluble powder material that is dissolved in a predetermined liquid or mixed with the predetermined liquid to be drunk, and
an internal volume of the container is set to a total of: a volume corresponding to a volume of the powder material contained in the container; a volume corresponding to an amount of the liquid determined in accordance with an amount of the powder material to be mixed or dissolved with the liquid; and a volume as an extra space to cause turbulence of the powder material and the liquid.

2. The hardly soluble beverage product as claimed in claim 1, wherein a ratio of the volume as the extra space to the amount of the liquid falls within a range from 20% to 85%.

3. The hardly soluble beverage product as claimed in claim 1,
wherein liquid nitrogen is delivered to the main body, and
an internal pressure of the container is set to a level higher than an atmospheric air pressure at a site where the cap is dismounted to put the liquid into the main body.

4. The hardly soluble beverage product as claimed in claim 1, wherein an upper limit of internal pressure of the main body is set to a level at which the powder material will not be ejected together with a gas when dismounting the cap.

5. The hardly soluble beverage product as claimed in claim 4, wherein the upper limit of the internal pressure of the main body is set to 50 kPa.

6. The hardly soluble beverage product as claimed in claim 1, wherein a lower limit of the internal pressure of the main body is set to 7 kPa.

7. The hardly soluble beverage product as claimed in claim 1, wherein the container includes a metallic can having a predetermined rigidity to maintain a shape thereof when dismounting the cap.

8. The hardly soluble beverage product as claimed in claim 1, wherein an outer diameter of the container mouth is equal to or larger than 38 mm.

9. The hardly soluble beverage product as claimed in claim 1, wherein a light transmissivity of the main body at an amount observing level to observe the amount of the liquid delivered to the container is equal to or greater than 30%.

10. The hardly soluble beverage product as claimed in claim 9, wherein a scale is printed on the main body at the amount observing level to observe the amount of the liquid delivered to the container.

11. The hardly soluble beverage product as claimed in claim 1, wherein the main body comprises:
a cylindrical trunk section;
a cylindrical neck section on which the container mouth is formed, and which is diametrically smaller than the trunk section; and
a shoulder section having a conical or domed shape formed between the trunk section and the neck section.

12. The hardly soluble beverage product as claimed in claim 1, wherein the powder material includes insoluble solid matter.

13. The hardly soluble beverage product as claimed in claim 1, wherein the powder material includes powdered protein and granulated protein.

14. The hardly soluble beverage product as claimed in claim 1, wherein an average particle size of the powder material falls within a range from 40 to 1200 μm.

15. The hardly soluble beverage product as claimed in claim 1, wherein the liquid includes tap water, hydrogen water, mineral water, ion water, milk, processed milk, and milk beverage.
